(19) United States
(12) Patent Application Publication
(10) Pub. No.: US 2015/0085686 A1
(43) Pub. Date: Mar. 26, 2015

(54) SCHEDULING BASED ON SIGNAL QUALITY MEASUREMENTS

(71) Applicant: QUALCOMM Incorporated, San Diego, CA (US)

(72) Inventors: Vinay CHANDE, San Diego, CA (US); Chirag Sureshbhai PATEL, San Diego, CA (US); Tamer Adel KADOUS, San Diego, CA (US)

(21) Appl. No.: 14/496,913

(22) Filed: Sep. 25, 2014

Related U.S. Application Data
(60) Provisional application No. 61/883,077, filed on Sep. 26, 2013.
(60) Provisional application No. 61/933,688, filed on Jan. 30, 2014.

(51) Int. Cl. H04W 72/12; H04W 72/04; H04L 5/00; H04W 24/08

(52) U.S. Cl. CPC H04W 72/1231; H04W 24/08; H04W 72/0446; H04L 5/0092
USPC 370/252

(57) ABSTRACT

Systems and methods for resource coordination and management in a communication environment are disclosed. The resource coordination and management may comprise, for example: transmitting channel and interference measurement signals over a plurality of resources; receiving link signal quality measurements that are based on the transmission of the channel and interference measurement signals over the plurality of resources; exchanging link signal quality measurement information with at least one apparatus, wherein the exchange of the link signal quality measurement information comprises sending information based on the received link signal quality measurements; and determining a data transmission schedule based on the exchange of the link signal quality measurement information.

### CROSS-REFERENCE TO RELATED APPLICATIONS

The present application for patent claims the benefit of U.S. Provisional Application No. 61/883,077, entitled “SCHEDULING BASED ON SIGNAL QUALITY MEASUREMENTS,” filed Sep. 26, 2013, and U.S. Provisional Application No. 61/933,688, entitled “SCHEDULING BASED ON SIGNAL QUALITY MEASUREMENTS,” filed Jan. 30, 2014, each assigned to the assignee hereof, and each expressly incorporated herein by reference in its entirety.

### INTRODUCTION

Aspects of this disclosure relate generally to telecommunications, and more particularly to communication resource coordination, management, and the like.

A wireless communication network may be deployed to provide various types of services (e.g., voice, data, multimedia services, etc.) to users within a coverage area of the network. In some implementations, one or more access points (e.g., corresponding to different cells) provide wireless connectivity for access terminals (e.g., cell phones) that are operating within the coverage of the access point(s). In some implementations, peer devices provide wireless connectively for communicating with one another.

In some networks, small cell access points (e.g., femto cells) are deployed to supplement conventional network access points (e.g., macro cells). For example, a small cell access point installed in a user's home or in an enterprise environment (e.g., commercial buildings) may provide voice and high speed data service for access terminals supporting cellular radio communication (e.g., Code Division Multiple Access (CDMA), Wideband Code Division Multiple Access (WCDMA), Universal Mobile Telecommunications System (UMTS), Third Generation Partnership Project (3GPP) Long Term Evolution (LTE), etc.). In general, these small cell access points provide more robust coverage and higher throughput for access terminals in the vicinity of the small cell access points.

A dense deployment of small cells (e.g., in an apartment building or commercial building) may suffer from inter-small cell interference. In general, this interference reduces user throughputs and network capacity.

Moreover, conventional resource coordination schemes are designed for working on an ideal backhaul and involve extensive information exchange. In general, such an approach is not desirable (or perhaps even feasible) for small cell deployments. For example, a small cell deployment might not have an ideal backhaul.

### SUMMARY

Systems and methods for resource coordination and management in a communication environment are disclosed.

A method of communication is disclosed. The method may comprise, for example: transmitting channel and interference measurement signals over a plurality of resources; receiving link signal quality measurements that are based on the transmission of the channel and interference measurement signals over the plurality of resources; exchanging link signal quality measurement information with at least one apparatus, wherein the exchange of the link signal quality measurement information comprises sending information based on the received link signal quality measurements; and determining a data transmission schedule based on the exchange of the link signal quality measurement information.

An apparatus for communication is also disclosed. The apparatus may comprise, for example, a transmitter, a receiver, a wired or wireless transceiver (which may or may not encompass the transmitter and/or receiver), and a processor. The transmitter may be configured to transmit channel and interference measurement signals over a plurality of resources. The receiver may be configured to receive link signal quality measurements that are based on the transmission of the channel and interference measurement signals over the plurality of resources. The wired or wireless transceiver may be configured to exchange link signal quality measurement information with at least one other apparatus, wherein the exchange of the link signal quality measurement information comprises sending information based on the received link signal quality measurements. The processor may be configured to determine a data transmission schedule based on the exchange of the link signal quality measurement information.

Another apparatus for communication is also disclosed. The apparatus may comprise, for example: means for transmitting channel and interference measurement signals over a plurality of resources; means for receiving link signal quality measurements that are based on the transmission of the channel and interference measurement signals over the plurality of resources; means for exchanging link signal quality measurement information with at least one apparatus, wherein the exchange of the link signal quality measurement information comprises sending information based on the received link signal quality measurements; and means for determining a data transmission schedule based on the exchange of the link signal quality measurement information.

A computer-readable medium is also disclosed that comprises instructions, which, when executed by a processor, cause the processor to perform operations for communication. The computer-readable medium may comprise, for example: instructions for transmitting channel and interference measurement signals over a plurality of resources; instructions for receiving link signal quality measurements that are based on the transmission of the channel and interference measurement signals over the plurality of resources; instructions for exchanging link signal quality measurement information with at least one apparatus, wherein the exchange of the link signal quality measurement information comprises sending information based on the received link signal quality measurements; and instructions for determining a data transmission schedule based on the exchange of the link signal quality measurement information.

### BRIEF DESCRIPTION OF THE DRAWINGS

These and other sample aspects of the disclosure will be described in the detailed description and the claims that follow, and in the accompanying drawings.

FIG. 1 is a simplified block diagram of several sample aspects of a communication system.

FIG. 2 is a simplified block diagram of several sample aspects of a communication system employing a central controller that performs data transmission scheduling.

FIG. 3 is a simplified block diagram of several sample aspects of a communication system where an access point performs data transmission scheduling.

FIG. 4 is flowchart of several sample aspects of operations that may be performed in conjunction with data transmission scheduling according to one implementation.

FIG. 5 is flowchart of several sample aspects of optional operations that may be performed in conjunction with data transmission scheduling.

FIG. 6 is flowchart of several sample aspects of operations that may be performed in conjunction with data transmission scheduling according to another implementation.

FIG. 7 is flowchart of several sample aspects of optional operations that may be performed in conjunction with data transmission scheduling.

FIG. 8 illustrates an example backhaul messaging scheme that may be employed to support scheduling and resource coordination as taught herein.

FIG. 9 is a simplified block diagram of several sample aspects of components that may be employed in communication nodes.

FIG. 10 is a simplified diagram of a wireless communication system.

FIG. 11 is a simplified diagram of a wireless communication system including small cells.

FIG. 12 is a simplified diagram illustrating coverage areas for wireless communication.

FIG. 13 is a simplified block diagram of several sample aspects of communication components.

FIGS. 14 and 15 are simplified block diagrams of several sample aspects of apparatuses configured to support communication as taught herein.

In accordance with common practice, various features illustrated in the drawings may not be drawn to scale. Accordingly, the dimensions of various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The disclosure relates in some aspects to determining data transmission schedules for access points (e.g., for small cell deployments). In general, the schedule is defined in an attempt to maximize overall network utility.

Various types of small cell access points may be employed in a given system. For example, small cell access points may be implemented as or referred to as low-power access points, femto cells, femto access points, femto nodes, home NodeBs (HNBs), home eNodeBs (HeNBs), access point base stations, pico cells, pico nodes, or micro cells.

For convenience, various such access points may be referred to simply as small cells in the discussion herein. Thus, it should be appreciated that any discussion related to small cells herein may be equally applicable to such access points in general (e.g., to femto cells, to micro cells, to pico cells, etc.). Also, the concepts disclosed herein may be applicable to macro cells or to mixed macro cell and small cell deployments.

The disclosure relates in some aspects to resource coordination and management for access points. For example, a data transmission schedule may be based, at least in part, on link signal quality measurements associated with the access points. To facilitate reliable measurement of the link signal quality, the resources used by the access points for transmitting channel and interference measurement signals are allocated in a manner that facilitates coordinated channel and interference measurement. For example, a central controller may decide which resources are to be used by which access points based on channel and interference measurement information that the central controller receives from the access points. As another example, the access points may cooperate with one another to determine which resources will be used by which access points.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim. For convenience, the term ‘some aspects’ may be used herein to refer to a single aspect or multiple aspects of the disclosure.

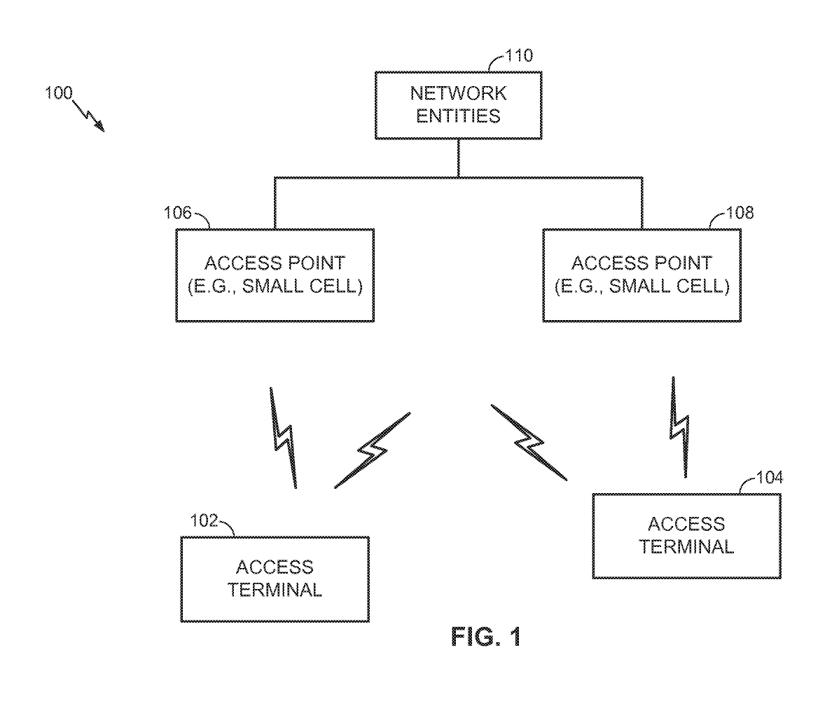

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 100 provide access to one or more services (e.g., network connectivity) for one or more wireless terminals (e.g., the access terminal 102 or the access terminal 104) that may be installed within or that may roam throughout a coverage area of the system 100. For example, at various points in time the access terminal 102 may connect to the access point 106, the access point 108, or some other access point in the system 100 (not shown). Similarly, the access terminal 104 may connect to the access point 106, the access point 108, or some other access point.

One or more of the access points may communicate with one or more network entities (represented, for convenience, by the network entities 110), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

In an implementation where the density of the access points in a given area of the system 100 is relatively high (e.g., in a small cell deployment), transmission by one access point may interfere with reception at an access terminal being served by another access point. For example, transmission by the access point 106 may interfere with reception at the access terminal 104 when the access terminal 104 is attempting to receive information from the access point 108.

Such interference may significantly degrade system performance. For example, in the presence of interference, it may be more difficult for an access terminal to reliably conduct link signal quality measurements. In addition, in the presence of interference, it may be more difficult for an access terminal to reliably receive data transmissions from an access point. Thus, there is a need to coordinate transmission of resources (e.g., time, frequency, and transmit power) to manage such interference.

The disclosure relates in some aspects to resource coordination and scheduling across access points to improve system performance (e.g., throughput and capacity). For purposes of illustration, the following discussion describes an implementation of resource coordination and scheduling in the context of an LTE small cell deployment. It should be appreciated, however, that the teachings herein are not limited to such a deployment.

Resource coordination across small cells may be performed via the three operations that follow.

First, each small cell receives downlink (DL) signal quality measurement information measured by one or more access terminals (e.g., UEs) served by the small cell. In some aspects, this link signal quality information is based on channel and interference measurement signals transmitted by the small cell(s). For example, an access terminal may measure reference signal received power (RSRP). As another example, an access terminal may measure a channel quality indicator (CQI) obtained from a combination of cell-specific reference signal (CRS) resources, channel state information reference signal (CSI-RS) resources, and interference management resources (IMR). In general, the information obtained during this first operation may be referred to as channel state information (CSI).

Second, to enable scheduling, the small cells exchange CSI (optionally along with other metrics) or send this information to a central controller. In some aspects, the CSI may comprise link signal quality information such as, for example, a channel quality indicator (CQI), a precoding matrix indicator (PMI), a rank indicator (RI), or a reference signal received power (RSRP) indicator.

In some aspects, the small cells that participate in the exchange of information may form a coordinating cluster. Also, in implementations that do not include a dedicated central controller, one of the small cells may perform the central controller functions.

Third, the central controller (or designated small cell) decides which of the small cells will be allowed to schedule its access terminal(s). The central controller may also decide which access terminal(s) will be scheduled in one or more small cells. The central controller then conveys this information to the small cells. In some aspects, this decision is based on maximizing total network utility (e.g., throughput, latency, quality of service (QoS)), subject to some constraints.

The three operations described above will now be discussed in more detail.

In some implementations, the CSI may be obtained in two ways. For example, CSI may be obtained via CQI feedback from one or more access terminals based on measurements of CRS, CSI-RS and IMR resources conducted by the access terminal(s). Alternatively or in addition, CQI may be derived by a small cell from RSRP measurement feedback from one or more access terminals. In the latter case, the RSRP measurement feedback may be augmented by relative narrowband transmission power (RNTP) messages from neighbor small cells.

To facilitate the acquisition of CSI, small cells may support self-configuration and/or coordination of resource transmissions.

For example, small cells may coordinate the transmission of CSI-RS and IMR so that the CQI corresponding to different small cell ON/OFF cases or transmissions using a given precoding can be obtained reliably.

In some aspects, this coordination may be accomplished via message exchange over a wired (e.g., X2) interface, message exchange via an operations, administration, and management (OAM) entity, over-the-air (OTA) message exchange, message exchange over wired or wireless backhaul, or message exchange via some other interface.

A central controller (network node or a designated small cell) can collect information indicative of whether a given small cell is a potential interferer for other small cells. Based on this information, the central controller assigns the small cell configuration of CSI-RS and IMR resources. For example, this assignment may be based on statistics of neighbor RSRPs received by the small cells, the locations of the small cells, or handover events between neighbor small cells. The configurations may be designed such that channel and interference can be measured for different combinations of neighbor small cell ON/OFF scenarios (where the ON/OFF is on one or more channels, e.g., data channels). Also, the configurations may be designed such that transmissions from small cells on the resources do not collide with each other. Also, the configurations may be designed such that transmissions from small cells collide only on some resources.

A message (e.g., on the X2 interface) may be defined to support the coordination among small cells and/or the coordination with a central controller. In some aspects, such a message may define the CSI-RS and/or IMR configuration. For example, the message may indicate the position (e.g., timing and subcarrier frequencies) of CSI-RS and IMR resources, the periodicity of CSI-RS and IMR resources, and the transmit power of any non-zero CSI-RS for a small cell.

In a distributed implementation, each small cell can negotiate with neighbor small cells by signaling its own CSI-RS and/or IMR configuration. In addition, each small cell may send a request to a neighbor small cell for a particular configuration.

Self-configuration of resources may be static, semi-static or dynamic. In some implementations, this configuration is part of automatic neighbor relation (ANR) procedures. For example, a small cell may maintain, in the ANR table, the CSI-RS and/or IMR configuration of neighbor small cells. Also, the small cell may learn the configuration of neighbors of neighbors and maintain this information as well. A small cell may thus adapt its own configuration based on this information. Also, the configuration may be adapted on an access-terminal-by-access-terminal basis for those access terminals served by the small cell. Thus, a small cell may use different resource configurations depending on which access terminals are being served.

As mentioned above, in some implementations, CSI may be derived from neighbor RSRPs received from an access terminal. Here, a small cell may request an access terminal to periodically report the RSRP for the small call and for any neighbor small cells.

The RSRP information can be converted to a CQI in the form of a signal-to-interference-and-noise ratio (SINR) or some form of data rate. Different CQI values may be generated for different combinations of neighbor small cells being ON or OFF. For example, consider three small cells: A, B, and C. Small cell A receives RSPB_A, RSRP_B, and RSRP_C. In this case, for small cell A, SINR (B_ON, C_ON) may be defined as RSRP_A/(RSRP_B+RSRP_C). In addition, SINR(B_ON, C_OFF) may be defined as RSRP_A/(RSRP_B), and so on.

In some implementations, the generated CQI can be filtered (e.g., averaged) or statistically processed in some way (e.g., by determining the median of the CQIs obtained over a certain duration).

In some implementations, the generated CQI can be augmented by RNTP reports from neighbor small cells. RNTP reports can describe whether a neighbor small cell is transmitting data or not on some resource blocks (RBs). If a neighbor small cell is not transmitting, SINR (CQI) can be adjusted accordingly. For example, SINR (CQI) may be increased due to the absence of neighbor interference, even though the CRS from which the RSRP is derived is still ON.

Referring now to the information exchange operations (the second operation) mentioned above, a small cell can exchange a combination of one or more of the following types of information with another small cell or a central controller.

A small cell may exchange the CSI reported by its access terminals (e.g., CQI, PMI, RI) along with underlying assumptions under which CSI was obtained. For example, the small cell may indicate that CSI X was obtained for CSI configuration Y (e.g., where Cell A was ON and Cell B was OFF, CSI-RS and/or IMR resources were transmitted on such and such time/frequency resources).

In some implementations, a small cell can pass on the CSI reported by its access terminals as is (i.e., without any processing).

Alternatively, a small cell may process the CSI it receives from its access terminals before passing on that CSI. Two examples of statistically processed CSI that may be exchanged follow. In a first example, CQI, PMI, RI received from an access terminal may be filtered by a small cell. For example, CQI may be adjusted for rate control back off. In a second example, a weighted CSI may be exchanged. For example, a small cell may associate a weighing factor with each CSI (e.g., to give higher weight to CQI from certain access terminals).

In some implementations, information other than CSI can be exchanged. For example, a small cell may map CSI to some effective access terminal link rate or throughput (e.g., short term rate, short term throughput, long term rate, or long term throughput achieved by the access terminal so far). In this case, the small cell may exchange this rate and/or throughput information instead of or in addition to CSI.

Other types of non-CSI information also may be exchanged. Such information may include queue sizes, an estimate of available backhaul bandwidth, and access terminal QoS requirements.

The above information may be exchanged for “N” access terminals served by the small cell. Persons skilled in the art will appreciate that “N” can be any suitable number of access terminals such as, for example, all of the access terminals, a subset of the access terminals with high CQI or link rate, a subset of the access terminals selected based on access terminal QoS requirements, or some other subset of the access terminals.

Referring now to the scheduling algorithm and actions (the third operation) mentioned above, the central controller or each small cell can make scheduling decisions based on information received from other small cells. These scheduling decisions are then conveyed to the small cells.

A scheduling decision sent to a small cell may specify various types of information. For example, a scheduling decision may indicate whether a given small cell is allowed to transmit data for the next X seconds. As another example, a scheduling decision may specify the transmit power a small cell is to use. Transmit power can be different on different time and/or frequency resources. If applicable, a scheduling decision also may indicate that multiple small cells will transmit simultaneously using certain resources.

In some implementations, a scheduling decision may be based on maximizing network utility (e.g., capacity, latency) while meeting a certain minimum performance (e.g., guaranteed minimum throughput to access terminals).

In some implementations, scheduling decisions can be exchanged at selected time intervals such as, for example, semi-statically (e.g., over a few tens or hundreds of subframes) or dynamically (e.g., every few 10 ms).

In some implementations, a scheduling decision can be conveyed to one or more small cells (e.g., small cells in a coordinating cluster and optionally small cells in non-coordinating clusters).

In some implementations, a small cell that receives a scheduling decision may send a confirmation or may send another message conveying its own scheduling decision.

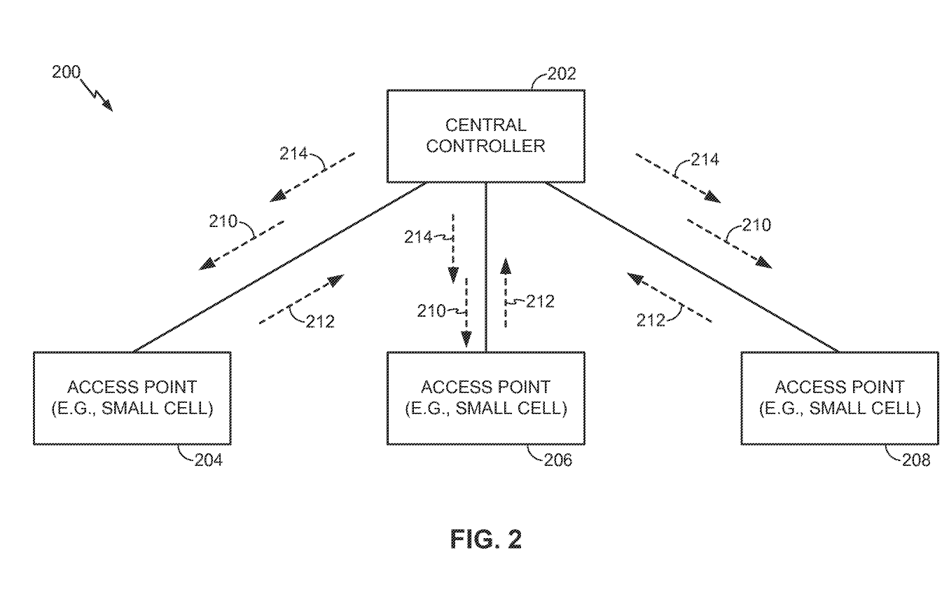

FIG. 2 illustrates an example of a communication system 200 where a central controller 202 can coordinate resource allocation for channel and interference measurement signals and can generate schedules for several access points 204, 206, and 208. For example, the central controller 202 can identify the resources to be used by each of the access points and can send an indication of these resources to each of the access points as indicated by the dashed lines 210. The access points, in turn, can send CSI to the central controller 202 as represented by the dashed lines 212. Based on this information the central controller 202 can generate a schedule for data transmission for each of the access points and can send an indication of the schedule to each of the access points as indicated by the dashed lines 214. Such an indication can be sent over an X2 interface via a message indicating one or more of the following: a data transmission schedule of time and frequency resources, a transmit power to be used, and/or a duration of transmission.

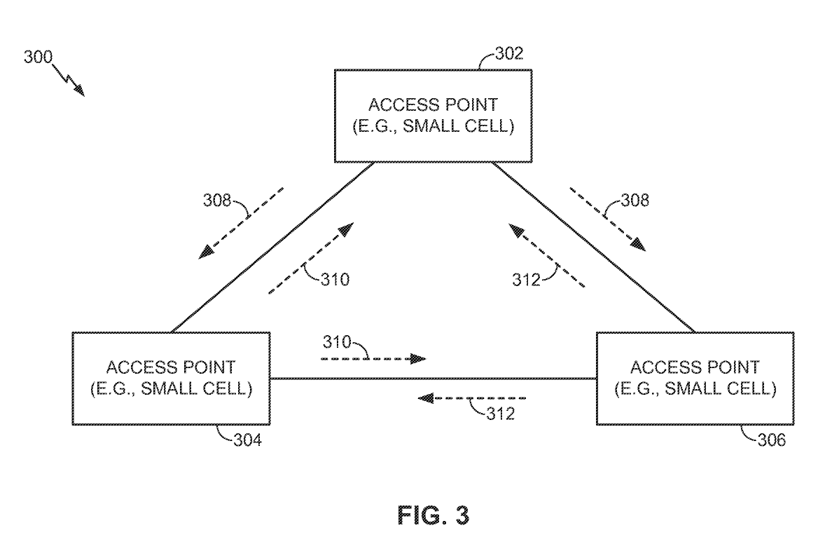

FIG. 3 illustrates an example of a communication system 300 where several access points 302, 304, and 306 can coordinate resource allocation for channel and interference measurement signals and can generate schedules. The access point 302 can share its CSI with the access points 304 and 306 as represented by the dashed lines 308. The access point 304 can share its CSI with the access points 302 and 306 as represented by the dashed lines 310. The access point 306 can share its CSI with the access points 302 and 304 as represented by the dashed lines 312. One of the access points may then generate a schedule for data transmission based on the CSI from all of the access points and send an indication of the schedule to each of the other access points.

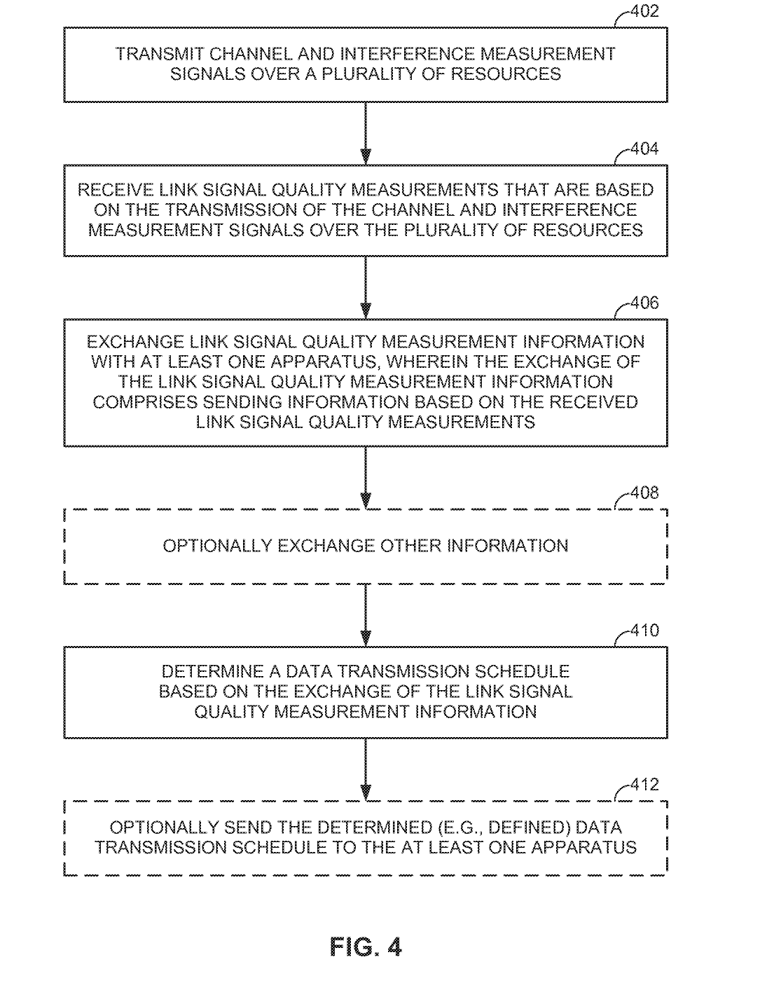

With the above in mind, additional operations relating to scheduling and resource coordination in accordance with the teachings herein will be described in more detail with reference to FIGS. 4-7. For convenience, the operations of FIGS. 4-7 (or any other operations discussed or taught herein) may be described as being performed by specific components. It should be appreciated, however, that these operations may be performed by other types of components and may be performed using a different number of components. For example, the operations of FIGS. 4-7 may be implemented in an access point, a network entity, or some other suitable type of device. It also should be appreciated that one or more of the operations described herein may not be employed in a given implementation.

FIG. 4 is an example of operations for determining a data transmission schedule based on link signal quality measurements.

As represented by block 402, channel and interference measurement signals are transmitted over a plurality of resources. As discussed herein, in some aspects, the resources may comprise at least one of: cell specific reference signal (CRS) resources, channel state information reference signal (CSI-RS) resources, or interference management resources (IMR).

As represented by block 404, link signal quality measurements are received. These measurements are based on the transmission of the channel and interference measurement signals over the plurality of resources at block 402. For example, an access point may receive this information from its served access terminals. In some aspects, the link signal quality measurements may comprise at least one of: a channel quality indicator (CQI), a precoding matrix indicator (PMI), a rank indicator (RI), or a reference signal received power (RSRP) indicator. Thus, the received link signal quality measurements may comprise measurements of reference signal power received at at least one access terminal for at least one apparatus.

As represented by block 406, link signal quality measurement information is exchanged with at least one apparatus (e.g., an access point may exchange this information with other access points in a cluster). Here, the exchange of the link signal quality measurement information includes sending information based on the received link signal quality measurements received at block 404. In some aspects, the exchanging of the link signal quality measurement information may comprise exchanging messages via an X2 interface or exchanging messages via an operations, administration, and management entity.

In some aspects, the link signal quality measurement information may comprise at least one of: a channel quality indicator (CQI), a precoding matrix indicator (PMI), a rank indicator (RI), or a reference signal received power (RSRP) indicator. For example, an access point may simply forward the link signal quality measurements the access point received from its access terminal to the other access points of a cluster. In some cases, the link signal quality measurement information can be derived from reference signal received power (RSRP) information.

As represented by optional block 408, other information may be exchanged. For example, an apparatus may exchange configurations of channel and interference measurement signals determined through coordination with the at least one apparatus. Also, in some implementations (e.g., where link signal quality measurement information is derived from RSRP information), an apparatus may exchange indications of access point conditions used to derive link signal quality. In addition, an apparatus may exchange ancillary information such as access terminal rate information, access terminal throughput information, queue size information, backhaul bandwidth information, or access terminal QoS requirements.

As represented by block 410, a data transmission schedule is determined based on the exchange of the link signal quality measurement information at block 406. In some aspects, the determined data transmission schedule may indicate at least one of: access point transmit timing, access point transmit power, transmit power for particular time and frequency resources, or simultaneous use of resources.

In some cases, the data transmission schedule can also be determined based on any information exchanged at block 408. For example, the determination of the data transmission schedule may be based on the exchanged configurations, the exchanged indications, or the exchanged ancillary information.

The determination of block 410 may involve different operations in different implementations. For example, in cases where another entity (e.g., central controller or another access point) defines the schedule for an access point, the determination of the data transmission schedule may comprise receiving the data transmission schedule (e.g., via an X2 interface). As another example, in cases where an access point defines its own schedule or the schedule for other access points, the determination of block 410 may comprise defining the data transmission schedule.

As represented by block 412, in implementations where the determination of block 410 involves defining the schedule, the apparatus (e.g., an access point) may send the schedule to at least one other apparatus (e.g., other access points in a cluster). For example, the message may be sent via an X2 interface.

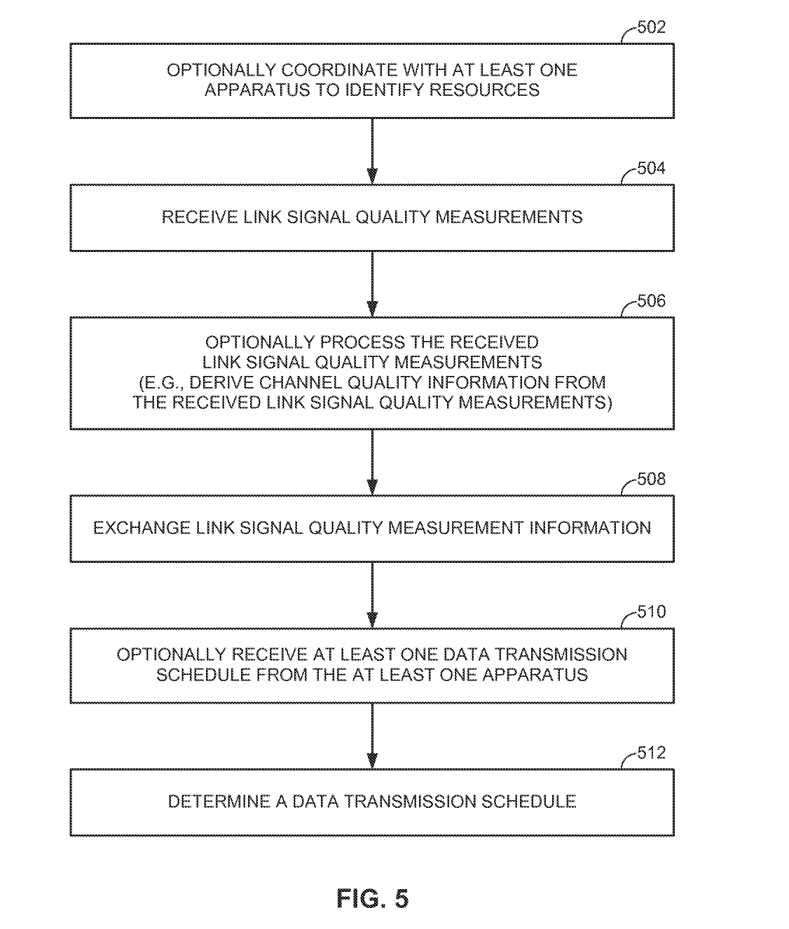

FIG. 5 is an example of optional operations that may be performed in conjunction with the data transmission scheduling of FIG. 4.

As represented by block 502, an apparatus may coordinate with at least one other apparatus to identify resources for transmitting channel and interference measurement signals. In some aspects, the coordination with at least one apparatus may comprise exchanging messages via an X2 interface or exchanging messages via an operations, administration, and management entity. In some aspects, the coordination with at least one apparatus may comprise sending an indication of resources being used by an access point, and receiving at least one indication of resources being used by at least one other access point. In some aspects, the coordination with at least one apparatus may comprise exchanging messages that indicate at least one of: positions of the resources, periodicity associated with the resources, or transmit power associated with the resources.

As represented by block 504, the apparatus receives link signal quality measurements that are based on the transmission of the channel and interference measurement signals over one or more of the resources identified at block 402. In some aspects, the operations of block 504 may correspond to the operations of blocks 402 and 404 of FIG. 4.

As represented by block 506, the link signal quality measurements received at block 504 may be processed by the apparatus. For example, these measurements may be filtered or statistically processed. As another example, channel quality information may be derived from the received link signal quality measurements.

As represented by block 508, link signal quality measurement information is exchanged with at least one apparatus (e.g., an access point may exchange this information with other access points in a cluster). In some aspects, the operations of block 508 may correspond to the operations of block 406 and 408 of FIG. 4. In some aspects, the information based on the received link signal quality measurements that is sent at block 406 may comprise the channel quality information derived at block 506 or the received link signal quality measurements processed at block 506.

As represented by block 510, at least one other data transmission schedule may be received from at least one other apparatus. For example, each access point of a cluster may define its own schedule and share it with the other access points in the cluster.

As represented by block 512, the apparatus determines a data transmission schedule (e.g. its own schedule). In some aspects, the operations of block 512 may correspond to the operations of block 410 of FIG. 4. In addition, this schedule may be based on (e.g., modified based on) the schedule of neighboring apparatuses received at block 510.

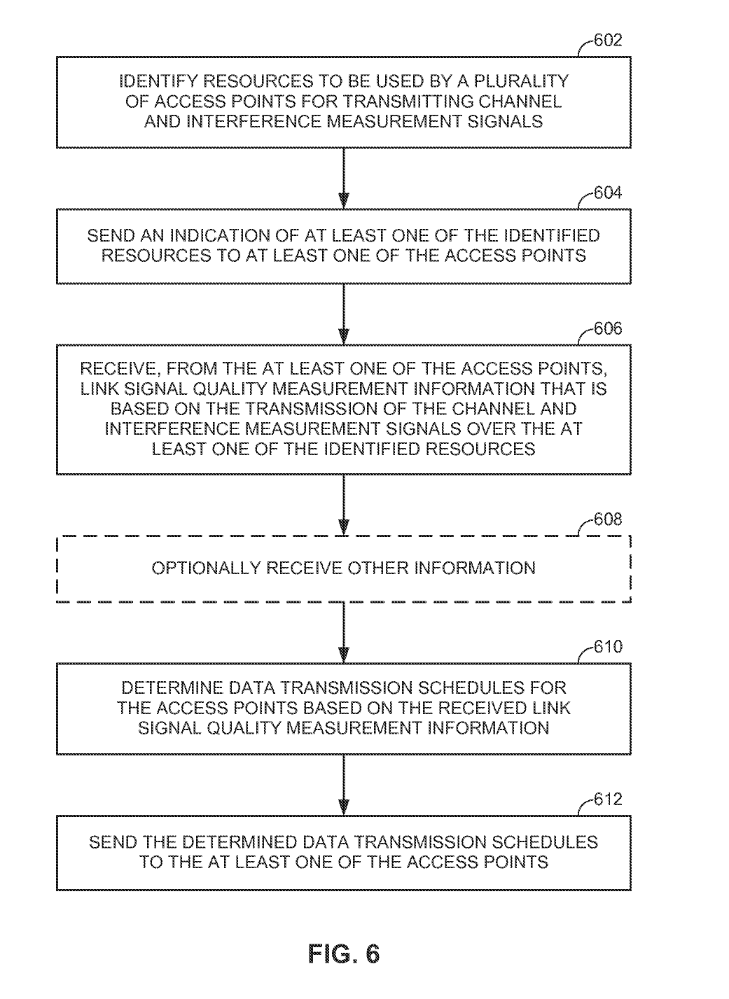

FIG. 6 is another example of operations for determining a data transmission schedule based on link signal quality measurements.

As represented by block 602, resources to be used by a plurality of access points for transmitting channel and interference measurement signals are identified. In some aspects, the identification of the resources may comprise: determining whether any of the access points potentially interferes with any other one of the access points; and, based on the determination whether any of the access points potentially interferes, allocating the resources among the access points to coordinate channel and interference measurements by associated access terminals. In some aspects, the identification of the resources may comprise coordinating with the at least one of the access points to identify the resources (e.g., by exchanging messages over X2). In some aspects, the identification of the resources may comprise receiving indications of resources being used by the at least one of the access points. Here, the identification of the resources may further comprise receiving messages that indicate at least one of: positions of the resources being used, periodicity associated with the resources being used, or transmit power associated with the resources being used.

As represented by block 604, an indication of at least one of the identified resources is sent to at least one of the access points. In some aspects, the sending of the indication may comprise sending messages that indicate at least one of: positions of the at least one of the identified resources, periodicity associated with the at least one of the identified resources, or transmit power associated with the at least one of the identified resources. In some aspects, the sending of the indication may comprise sending messages via an X2 interface or sending messages via an operations, administration, and management entity.

As represented by block 606, link signal quality measurement information is received from the at least one of the access points (e.g., via an X2 interface). This information is based on the transmission of the channel and interference measurement signals over the at least one of the identified resources.

As represented by optional block 608, other information may be received. For example, an apparatus may receive configurations of channel and interference measurement signals determined through coordination with the at least one of the access points. Also, an apparatus may receive indications of access point conditions used to derive link signal quality. In addition, an apparatus may receive ancillary information (e.g., the information discussed at block 408).

As represented by block 610, data transmission schedules for the access points are determined based on the link signal quality measurement information received at block 606. The determination of the data transmission schedules also may be based on any information received at block 608 (e.g., received configurations, received indications, or received ancillary information).

As represented by block 612, the determined data transmission schedules are sent to the at least one of the access points (e.g., via an X2 interface).

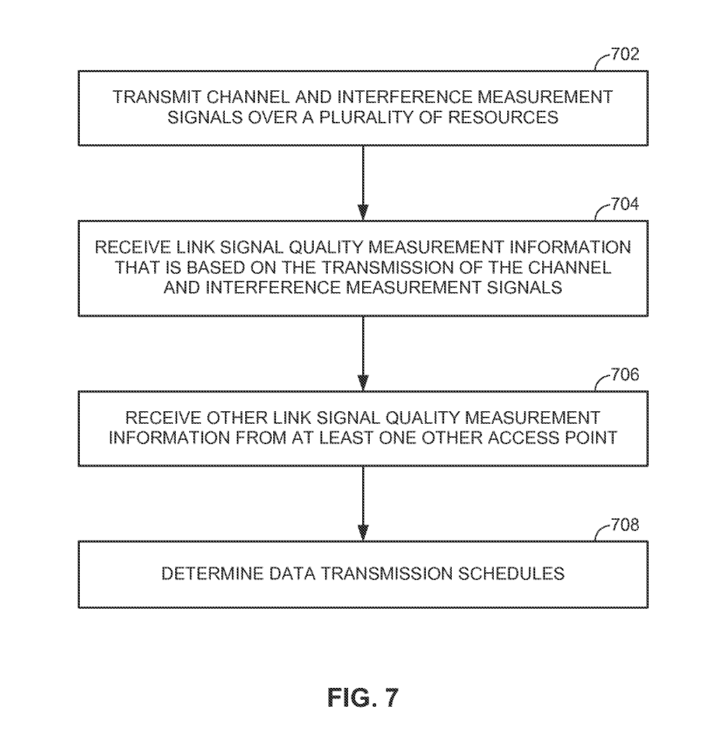

FIG. 7 is an example of optional operations that may be performed in conjunction with the data transmission scheduling of FIG. 6. These operations may be performed, for example, by an access point that serves as the central controller.

As represented by block 702, channel and interference measurement signals are transmitted over designated resources. For example, these signals may be transmitted over some of the resources identified at block 602 of FIG. 6.

As represented by block 704, link signal quality measurement information is received. This information is based on (e.g., received as a result of) the transmission of the channel and interference measurement signals at block 702.

As represented by block 706, other link signal quality measurement information may be received from at least one other access point. In some aspects, the operations of block 706 may correspond to the operations of block 606 of FIG. 6. Thus, this other information may be based on the transmission of the channel and interference measurement signals over the at least one other one of the identified resources.

As represented by block 708, data transmission schedules for the access points are determined based on the link signal quality measurement information received at block 704, and optionally based on any information received at block 706. In some aspects, the determination of the data transmission schedules is based on the link signal quality measurement information received at block 704.

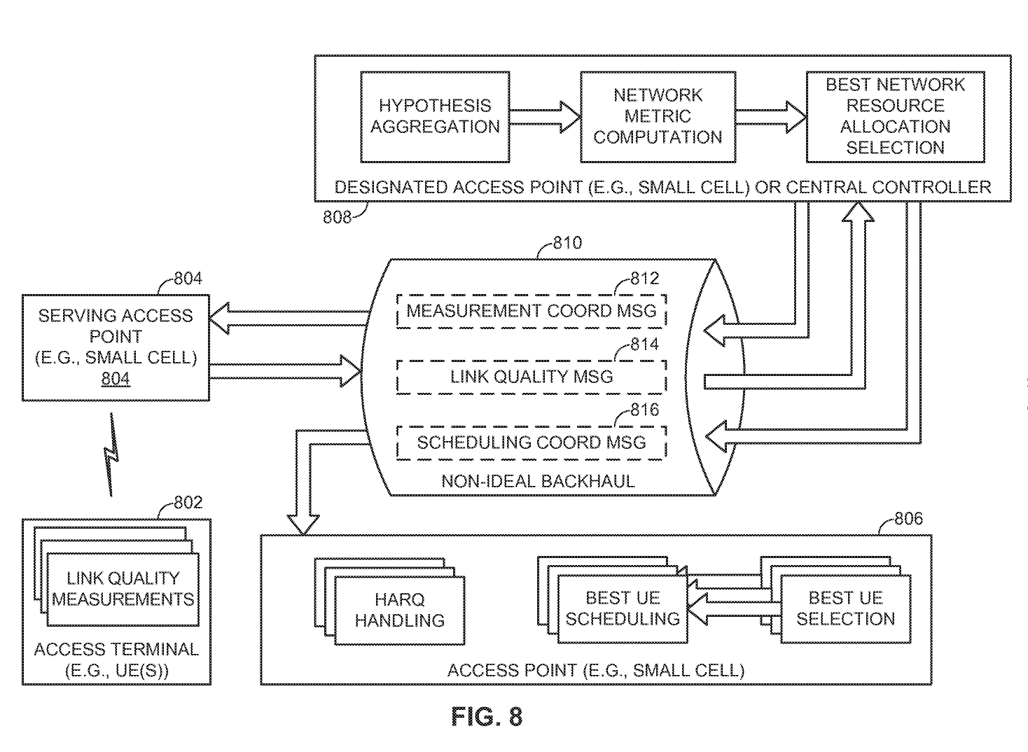

FIG. 8 illustrates an example backhaul messaging scheme that may be employed to support scheduling and resource coordination as taught herein. In this example, an access terminal 802 (e.g., one or more UEs) collects link quality measurements and sends them to a serving access point 804 (e.g., a small cell) serving the access terminal 802. The serving access point 804 forms part of a coordinating cluster with other entities, including another access point 806 (e.g., another small cell) and a designated access point or central controller 808 (e.g., another small cell or other central entity). The serving access point 804, access point 806, and designated access point or central controller 808 are all communicatively coupled via a non-ideal backhaul 810, as shown. Because conventional resource coordination schemes are designed for working on an ideal backhaul that involve extensive information exchange, such an approach is not desirable (or perhaps even feasible) for small cell deployments. Thus, given the potential for very high densities in small cell deployments, less complex solutions may be desired.

In order to facilitate scheduling and resource coordination, modifications to the backhaul signaling protocol (e.g., X2) may be implemented to define various associated messages, as appropriate. Several example message formats are discussed below.

For measurement coordination, a measurement coordination message 812 may be defined for the backhaul signaling protocol to identify resources for transmitting channel and interference measurement signals. As shown in FIG. 8, the measurement coordination message 812 may be exchanged between the access point 804 and the designated access point or central controller 808 via the non-ideal backhaul 810. In some aspects, such a message may define the CSI-RS and/or IMR configuration. For example, the message may indicate the position (e.g., timing and subcarrier frequencies) of CSI-RS and IMR resources, the periodicity of CSI-RS and IMR resources, and the transmit power of any non-zero CSI-RS for a small cell.

For link quality measurement exchange, a link quality message 814 may be defined for the backhaul signaling protocol to indicate link signal quality measurement information for one or more associated access terminals. As shown in FIG. 8, the link quality message 814 may be exchanged between the access point 804 and the designated access point or central controller 808 via the non-ideal backhaul 810. In some aspects, such a message may include an indicator associated with the link signal quality measurements of the access terminal 802. For example, the message may comprise at least one of: a CQI, a PMI, an RI, or an RSRP indicator. In some cases, an access point may simply forward the link signal quality measurements the access point received from its access terminal to the other access points of a cluster. In other cases, the link signal quality measurement information is derived from the (e.g., RSRP) information.

For scheduling coordination, a scheduling coordination message 816 may be defined for the backhaul signaling protocol to provide a data transmission schedule for the access points in the cluster. The data transmission schedule may be based on the exchange of the link signal quality measurement information, and may be determined in different ways as discussed in more detail above (e.g., hypothesis aggregation, network metric computation, and best network resource allocation selection). As shown in FIG. 8, the scheduling coordination message 816 may be exchanged between the designated access point or central controller 808 and the access point 806 via the non-ideal backhaul 810. In some aspects, such a message may define which resources will be used by which access points. For example, the message may indicate one or more of the following: access point transmit timing, access point transmit power, transmit power for particular time and frequency resources, or simultaneous use of resources. The data transmission schedule may be used by the access points in different ways (e.g., for HARQ handling, best UE selection, best UE scheduling, etc.).

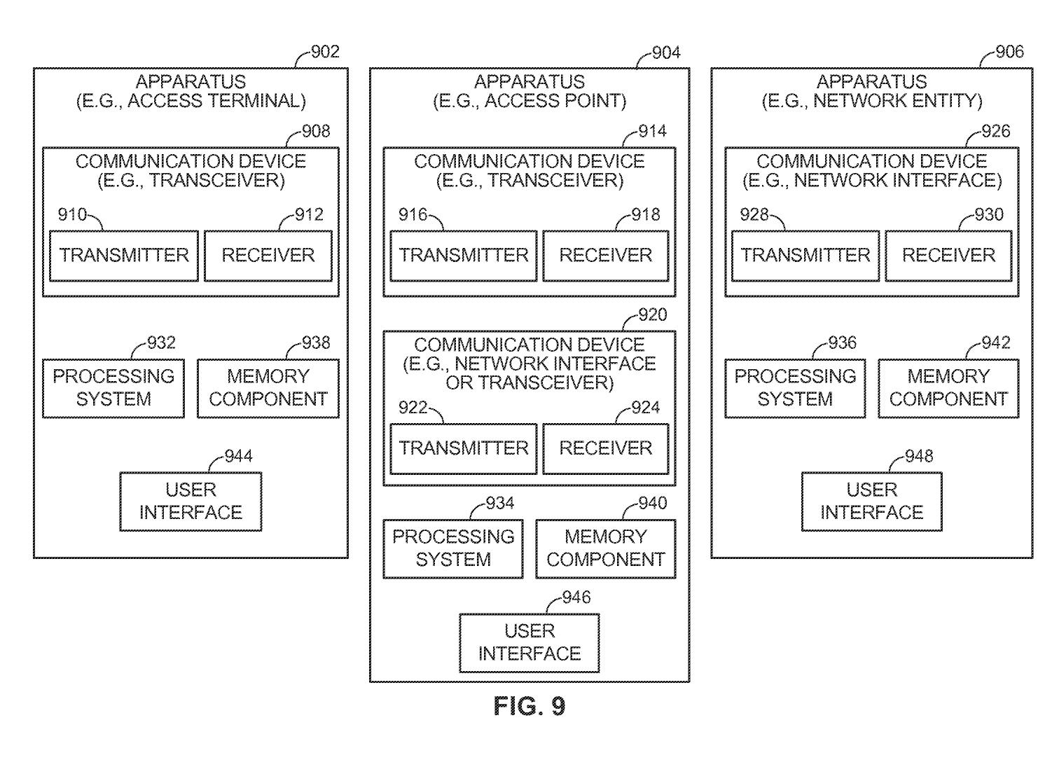

FIG. 9 illustrates several sample components (represented by corresponding blocks) that may be incorporated into an apparatus 902, an apparatus 904, and an apparatus 906 (e.g., corresponding to an access terminal, an access point, and a network entity, respectively) to support scheduling and resource coordination as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 902 and the apparatus 904 each include at least one wireless communication device (represented by the communication devices 908 and 914 (and the communication device 920 if the apparatus 904 is a relay)) for communicating with other nodes via at least one designated radio access technology. Each communication device 908 includes at least one transmitter (represented by the transmitter 910) for transmitting and encoding signals (e.g., messages, indications, information, and so on) and at least one receiver (represented by the receiver 912) for receiving and decoding signals (e.g., messages, indications, information, pilots, and so on). Similarly, each communication device 914 includes at least one transmitter (represented by the transmitter 916) for transmitting signals (e.g., messages, indications, information, pilots, and so on) and at least one receiver (represented by the receiver 918) for receiving signals (e.g., messages, indications, information, and so on). If the apparatus 904 is a relay access point, each communication device 920 may include at least one transmitter (represented by the transmitter 922) for transmitting signals (e.g., messages, indications, information, pilots, and so on) and at least one receiver (represented by the receiver 924) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 904 comprises a network listen module.

The apparatus 906 (and the apparatus 904 if it is not a relay access point) can include at least one communication device (represented by the communication device 926 and, optionally, 920) for communicating with other nodes. For example, the communication device 926 may comprise a network interface that is configured to communicate with one or more network entities via a wire-based or wireless backhaul. In some aspects, the communication device 926 may be implemented as a transceiver configured to support wire-based or wireless signal communication. This communication may involve, for example, sending and receiving: messages, parameters, or other types of information. Accordingly, in the example of FIG. 9, the communication device 926 is shown as comprising a transmitter 928 and a receiver 930. Similarly, if the apparatus 904 is not a relay access point, the communication device 920 may comprise a network interface that is configured to communicate with one or more network entities via a wire-based or wireless backhaul. As with the communication device 926, the communication device 920 is shown as comprising a transmitter 922 and a receiver 924.

The apparatuses 902, 904, and 906 can also include other components that may be used in conjunction with scheduling and resource coordination operations as taught herein. The apparatus 902 can include a processing system 932 for providing functionality relating to, for example, communicating with an access point to support scheduling and resource coordination as taught herein and for providing other processing functionality. The apparatus 904 can include a processing system 934 for providing functionality relating to, for example, scheduling and resource coordination as taught herein and for providing other processing functionality. The apparatus 906 can include a processing system 936 for providing functionality relating to, for example, scheduling and resource coordination as taught herein and for providing other processing functionality. The apparatuses 902, 904, and 906 can include memory devices 938, 940, and 942 (e.g., each including a memory device), respectively, for maintaining information (e.g., information indicative of reserved resources, thresholds, parameters, and so on). In addition, the apparatuses 902, 904, and 906 can include user interface devices 944, 946, and 948, respectively, for providing indications (e.g., audible and/or visual indications) to a user and/or for receiving user input (e.g., upon user actuation of a sensing device such as a keypad, a touch screen, a microphone, and so on).

For convenience, the apparatus 902 is shown in FIG. 9 as including components that may be used in the various examples described herein. In practice, the illustrated blocks may have different functionality in different aspects. For example, functionality of the block 934 for supporting the scheduling and resource coordination of FIG. 4 may be different as compared to functionality of the block 934 for supporting the scheduling and resource coordination of FIG. 6.

The components of FIG. 9 may be implemented in various ways. In some implementations, the components of FIG. 9 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 908, 932, 938, and 944 may be implemented by processor and memory component(s) of the apparatus 902 (e.g., by execution of appropriate code and/or by appropriate configuration of processor components). Similarly, some or all of the functionality represented by blocks 914, 920, 934, 940, and 946 may be implemented by processor and memory component(s) of the apparatus 904 (e.g., by execution of appropriate code and/or by appropriate configuration of processor components). Also, some or all of the functionality represented by blocks 926, 936, 942, and 948 may be implemented by processor and memory component(s) of the apparatus 906 (e.g., by execution of appropriate code and/or by appropriate configuration of processor components).

As mentioned above, some of the access points referred to herein may comprise small cell access points. As used herein, the term small cell access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each small cell access point has a transmit power (e.g., as defined above) that is less than a transmit power (e.g., as defined above) of the macro access point by a relative margin (e.g., 10 dBm or more). In some implementations, small cell access points such as femto cells may have a maximum transmit power of 20 dBm or less. In some implementations, small cell access points such as pico cells may have a maximum transmit power of 24 dBm or less. It should be appreciated, however, that these or other types of small cell access points may have a higher or lower maximum transmit power in other implementations (e.g., up to 1 Watt in some cases, up to 10 Watts in some cases, and so on).

Typically, small cell access points connect to the Internet via a broadband connection (e.g., a digital subscriber line (DSL) router, a cable modem, or some other type of modem) that provides a backhaul link to a mobile operator's network. Thus, a small cell access point deployed in a user's home or business provides mobile network access to one or more devices via the broadband connection.

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

Thus, in some aspects the teachings herein may be employed in a network that includes macro scale coverage (e.g., a large area cellular network such as a 3G network, typically referred to as a macro cell network or a wide area network (WAN)) and smaller scale coverage (e.g., a residence-based or building-based network environment, typically referred to as a local area network (LAN)). As an access terminal moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with various types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

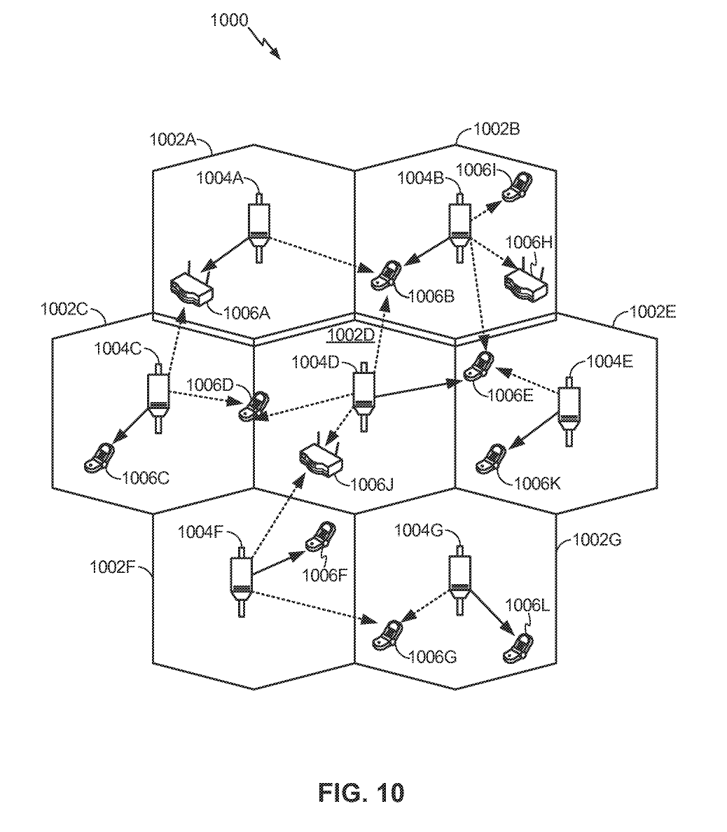

FIG. 10 illustrates a wireless communication system 1000, configured to support a number of users, in which the teachings herein may be implemented. The system 1000 provides communication for multiple cells 1002, such as, for example, macro cells 1002A-1002G, with each cell being serviced by a corresponding access point 1004 (e.g., access points 1004A-1004G). As shown in FIG. 10, access terminals 1006 (e.g., access terminals 1006A-1006L) may be dispersed at various locations throughout the system over time. Each access terminal 1006 may communicate with one or more access points 1004 on a forward link (FL) and/or a reverse link (RL) at a given moment, depending upon whether the access terminal 1006 is active and whether it is in soft handoff, for example. The wireless communication system 1000 may provide service over a large geographic region. For example, macro cells 1002A-1002G may cover a few blocks in a neighborhood or several miles in a rural environment.

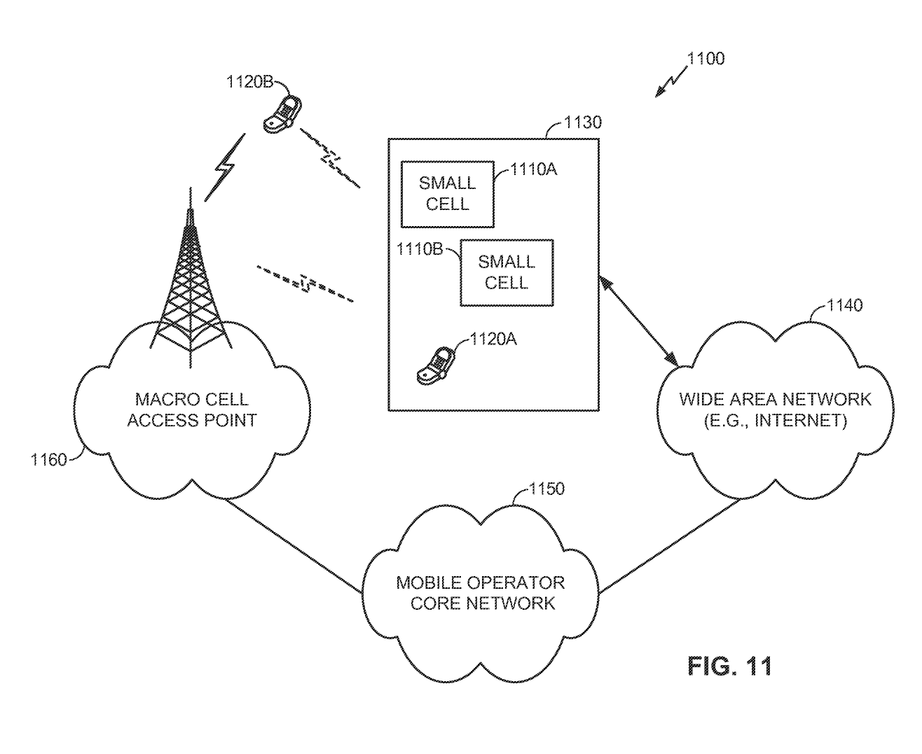

FIG. 11 illustrates an example of a communication system 1100 where one or more small cells are deployed within a network environment. Specifically, the system 1100 includes multiple small cells 1110 (e.g., small cells 1110A and 1110B) installed in a relatively small scale network environment (e.g., in one or more user residences 1130). Each small cell 1110 may be coupled to a wide area network 1140 (e.g., the Internet) and a mobile operator core network 1150 via a DSL router, a cable modem, a wireless link, or other connectivity means (not shown). As will be discussed below, each small cell 1110 may be configured to serve associated access terminals 1120 (e.g., access terminal 1120A) and, optionally, other (e.g., hybrid or alien) access terminals 1120 (e.g., access terminal 1120B). In other words, access to small cells 1110 may be restricted whereby a given access terminal 1120 may be served by a set of designated (e.g., home) small cell(s) 1110 but may not be served by any non-designated small cells 1110 (e.g., a neighbor's small cell 1110).

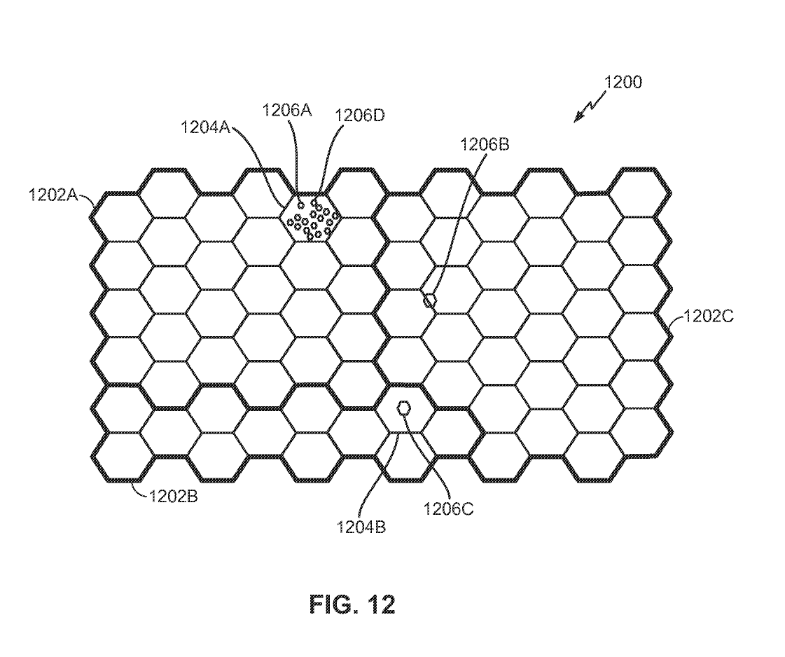

FIG. 12 illustrates an example of a coverage map 1200 where several tracking areas 1202 (or routing areas or location areas) are defined, each of which includes several macro coverage areas 1204. Here, areas of coverage associated with tracking areas 1202A, 1202B, and 1202C are delineated by the wide lines and the macro coverage areas 1204 are represented by the larger hexagons. The tracking areas 1202 also include small cell coverage areas 1206. In this example, each of the small cell coverage areas 1206 (e.g., small cell coverage areas 1206B and 1206C) is depicted within one or more macro coverage areas 1204 (e.g., macro coverage areas 1204A and 1204B). It should be appreciated, however, that some or all of a small cell coverage area 1206 might not lie within a macro coverage area 1204. In practice, a large number of small cell coverage areas 1206 (e.g., small cell coverage areas 1206A and 1206D) may be defined within a given tracking area 1202 or macro coverage area 1204.

Referring again to FIG. 11, the owner of a small cell 1110 may subscribe to mobile service, such as, for example, 3G mobile service, offered through the mobile operator core network 1150. In addition, an access terminal 1120 may be capable of operating both in macro environments and in smaller scale (e.g., residential) network environments. In other words, depending on the current location of the access terminal 1120, the access terminal 1120 may be served by a macro cell access point 1160 associated with the mobile operator core network 1150 or by any one of a set of small cells 1110 (e.g., the small cells 1110A and 1110B that reside within a corresponding user residence 1130). For example, when a subscriber is outside his home, he is served by a standard macro access point (e.g., access point 1160) and when the subscriber is at home, he is served by a small cell (e.g., small cell 1110A). Here, a small cell 1110 may be backward compatible with legacy access terminals 1120.

A small cell 1110 may be deployed on a single frequency or, in the alternative, on multiple frequencies. Depending on the particular configuration, the single frequency or one or more of the multiple frequencies may overlap with one or more frequencies used by a macro access point (e.g., access point 1160).

In some aspects, an access terminal 1120 may be configured to connect to a preferred small cell (e.g., the home small cell of the access terminal 1120) whenever such connectivity is possible. For example, whenever the access terminal 1120A is within the user's residence 1130, it may be desired that the access terminal 1120A communicate only with the home small cell 1110A or 1110B.

In some aspects, if the access terminal 1120 operates within the macro cellular network 1150 but is not residing on its most preferred network (e.g., as defined in a preferred roaming list), the access terminal 1120 may continue to search for the most preferred network (e.g., the preferred small cell 1110) using a better system reselection (BSR) procedure, which may involve a periodic scanning of available systems to determine whether better systems are currently available and subsequently acquire such preferred systems. The access terminal 1120 may limit the search for a specific band and channel. For example, one or more small cell channels may be defined whereby all small cells (or all restricted small cells) in a region operate on the small cell channel(s). The search for the most preferred system may be repeated periodically. Upon discovery of a preferred small cell 1110, the access terminal 1120 selects the small cell 1110 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 1110 that reside within the corresponding user residence 1130). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplexing (TDD) and frequency division duplexing (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

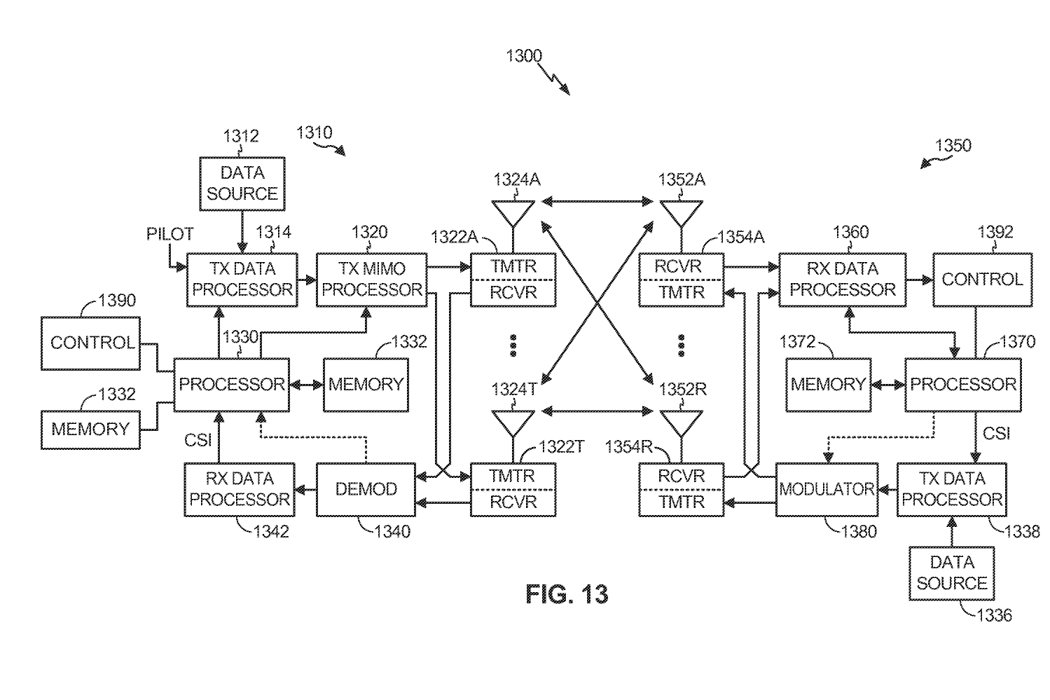

FIG. 13 illustrates a wireless device 1310 (e.g., an access point) and a wireless device 1350 (e.g., an access terminal) of a sample MIMO system 1300. At the device 1310, traffic data for a number of data streams is provided from a data source 1312 to a transmit (TX) data processor 1314. Each data stream may then be transmitted over a respective transmit antenna.

The TX data processor 1314 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1330. A data memory 1332 may store program code, data, and other information used by the processor 1330 or other components of the device 1310.

The modulation symbols for all data streams are then provided to a TX MIMO processor 1320, which may further process the modulation symbols (e.g., for OFDM). The TX MIMO processor 1320 then provides N_{T} modulation symbol streams to N_{T} transceivers (XCVR) 1322A through 1322T. In some aspects, the TX MIMO processor 1320 applies beam-forming weights to the symbols of the data streams and to the antenna from which the symbol is being transmitted.

Each transceiver 1322 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1322A through 1322T are then transmitted from N_{T} antennas 1324A through 1324T, respectively.

At the device 1350, the transmitted modulated signals are received by N_{R} antennas 1352A through 1352R and the received signal from each antenna 1352 is provided to a respective transceiver (XCVR) 1354A through 1354R. Each transceiver 1354 conditions (e.g., filters, amplifies, and downconverts) a respective received signal, digitizes the conditioned signal to provide samples, and further processes the samples to provide a corresponding “received” symbol stream.

A receive (RX) data processor 1360 then receives and processes the N_{R} received symbol streams from N_{R} transceivers 1354 based on a particular receiver processing technique to provide N_{T} “detected” symbol streams. The RX data processor 1360 then demodulates, deinterleaves, and decodes each detected symbol stream to recover the traffic data for the data stream. The processing by the RX data processor 1360 is complementary to that performed by the TX MIMO processor 1320 and the TX data processor 1314 at the device 1310.

A processor 1370 periodically determines which pre-coding matrix to use (discussed below). The processor 1370 formulates a reverse link message comprising a matrix index portion and a rank value portion. A data memory 1372 may store program code, data, and other information used by the processor 1370 or other components of the device 1350.

The reverse link message may comprise various types of information regarding the communication link and/or the received data stream. The reverse link message is then processed by a TX data processor 1338, which also receives traffic data for a number of data streams from a data source 1336, modulated by a modulator 1380, conditioned by the transceivers 1354A through 1354R, and transmitted back to the device 1310.

At the device 1310, the modulated signals from the device 1350 are received by the antennas 1324, conditioned by the transceivers 1322, demodulated by a demodulator (DEMOD) 1340, and processed by a RX data processor 1342 to extract the reverse link message transmitted by the device 1350. The processor 1330 then determines which pre-coding matrix to use for determining the beam-forming weights, then processes the extracted message.

FIG. 13 also illustrates that the communication components may include one or more components that perform scheduling and resource coordination operations as taught herein. For example, a control component 1390 may cooperate with the processor 1330 and/or other components of the device 1310 to perform scheduling and resource coordination as taught herein. Similarly, a control component 1392 may cooperate with the processor 1370 and/or other components of the device 1350 to support scheduling and resource coordination as taught herein. It should be appreciated that for each device 1310 and 1350 the functionality of two or more of the described components may be provided by a single component. For example, a single processing component may provide the functionality of the control component 1390 and the processor 1330 and a single processing component may provide the functionality of the control component 1392 and the processor 1370.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

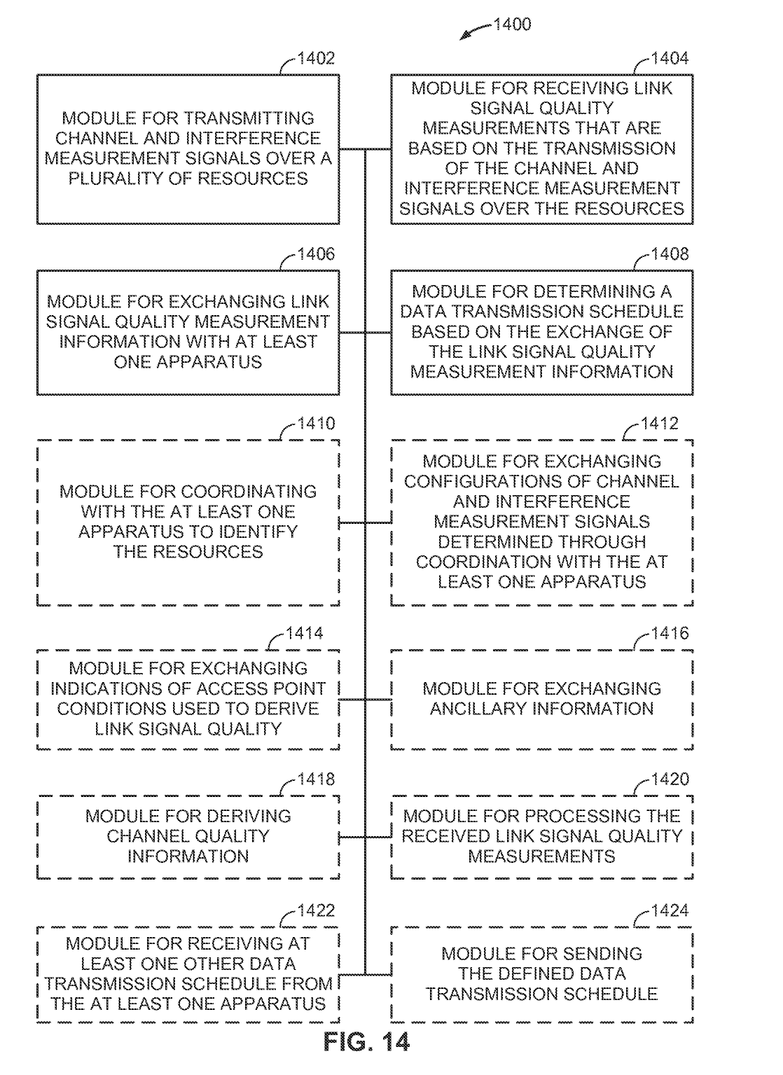

Referring to FIG. 14, an apparatus 1400 is represented as a series of interrelated functional modules. A module for transmitting 1402 may correspond at least in some aspects to, for example, a communication device (e.g., a transmitter) as discussed herein. A module for receiving 1404 may correspond at least in some aspects to, for example, a communication device (e.g., a receiver) as discussed herein. A module for exchanging 1406 may correspond at least in some aspects to, for example, a processing system as discussed herein. A module for determining 1408 may correspond at least in some aspects to, for example, a processing system as discussed herein. A module for coordinating 1410 may correspond at least in some aspects to, for example, a processing system as discussed herein. A module for exchanging 1412 may correspond at least in some aspects to, for example, a processing system as discussed herein. A module for exchanging 1414 may correspond at least in some aspects to, for example, a processing system as discussed herein. A module for exchanging 1416 may correspond at least in some aspects to, for example, a processing system as discussed herein. A module for deriving 1418 may correspond at least in some aspects to, for example, a processing system as discussed herein. A module for processing 1420 may correspond at least in some aspects to, for example, a processing system as discussed herein. A module for receiving 1422 may correspond at least in some aspects to, for example, a communication device (e.g., a receiver) as discussed herein. A module for sending 1424 may correspond at least in some aspects to, for example, a communication device (e.g., a transmitter) as discussed herein.

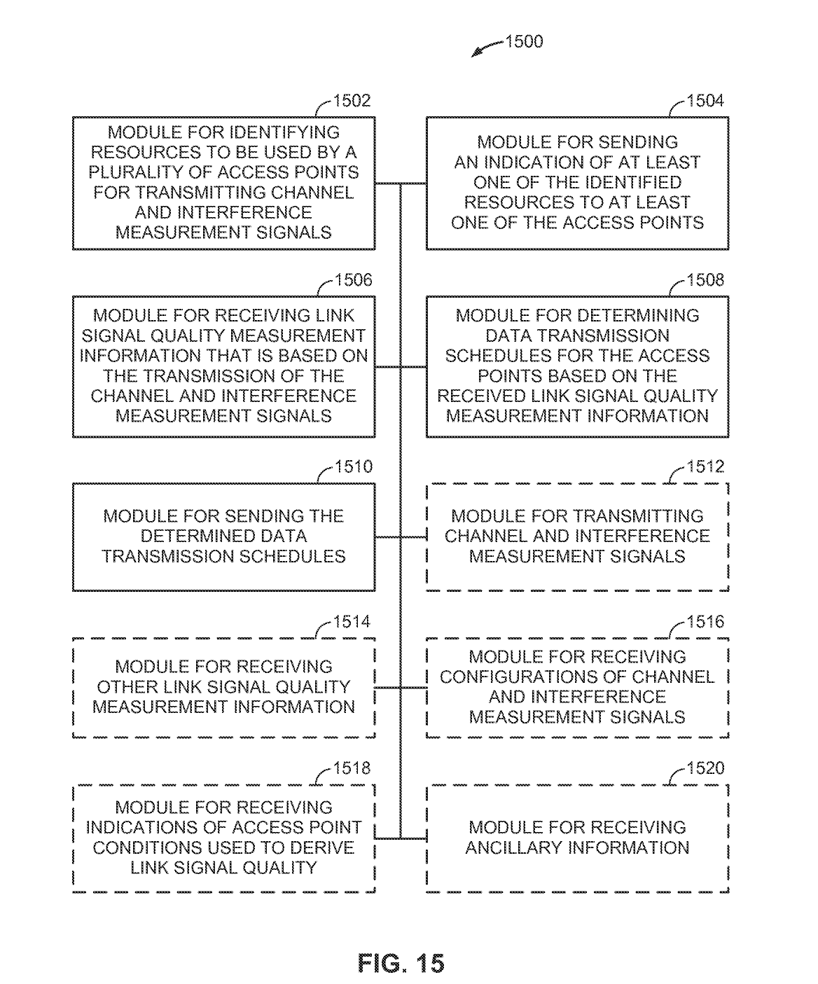

Referring to FIG. 15, an apparatus 1500 is represented as a series of interrelated functional modules. A module for identifying 1502 may correspond at least in some aspects to, for example, a processing system as discussed herein. A module for sending 1504 may correspond at least in some aspects to, for example, a communication device (e.g., a transmitter) as discussed herein. A module for receiving 1506 may correspond at least in some aspects to, for example, a communication device (e.g., a receiver) as discussed herein. A module for determining 1508 may correspond at least in some aspects to, for example, a processing system as discussed herein. A module for sending 1510 may correspond at least in some aspects to, for example, a communication device (e.g., a transmitter) as discussed herein. A module for transmitting 1512 may correspond at least in some aspects to, for example, a communication device (e.g., a transmitter) as discussed herein. A module for receiving 1514 may correspond at least in some aspects to, for example, a communication device (e.g., a receiver) as discussed herein. A module for receiving 1516 may correspond at least in some aspects to, for example, a communication device (e.g., a receiver) as discussed herein. A module for receiving 1518 may correspond at least in some aspects to, for example, a communication device (e.g., a receiver) as discussed herein. A module for receiving 1520 may correspond at least in some aspects to, for example, a communication device (e.g., a receiver) as discussed herein.

The functionality of the modules of FIGS. 14 and 15 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1500 may comprise a single device (e.g., components 1502-1520 comprising different sections of an ASIC). As another specific example, the apparatus 1500 may comprise several devices (e.g., the components 1502 and 1508 comprising one ASIC, the components 1504, 1510, 1516, 1518, and 1520 comprising another ASIC, and the components 1506, 1512, and 1514 comprising another ASIC). The functionality of these modules also may be implemented in some other manner as taught herein. In some aspects, one or more of any dashed blocks in FIGS. 14 and 15 are optional.

In addition, the components and functions represented by FIGS. 14 and 15 as well as other components and functions described herein, may be implemented using any suitable means. Such means also may be implemented, at least in part, using corresponding structure as taught herein. For example, the components described above in conjunction with the “module for” components of FIGS. 14 and 15 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise, a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that any of the various illustrative logical blocks, modules, processors, means, circuits, and algorithm operations described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It will be understood that any specific order or hierarchy of operations in any disclosed process is an example of a sample approach. Based upon design preferences, it will be understood that the specific order or hierarchy of operations in the processes may be rearranged while remaining within the scope of the present disclosure. The accompanying method claims present elements of the various operations in a sample order, and are not meant to be limited to the specific order or hierarchy presented.

The operations of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more implementations, the functions described may be implemented in hardware, software, firmware, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A computer-readable medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc, where disks usually reproduce data magnetically and discs reproduce data optically with lasers. Thus, in some aspects, computer-readable media may comprise non-transitory computer-readable media (e.g., tangible media, computer-readable storage media, computer-readable storage devices, etc.). Such a non-transitory computer-readable medium (e.g., computer-readable storage device) may comprise any of the tangible forms of media described herein or otherwise known (e.g., a memory device, a media disk, etc.). In addition, in some aspects, computer-readable media may comprise transitory computer readable media (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make and use the various implementations of the present disclosure. Various modifications to certain aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
transmitting channel and interference measurement signals over a plurality of resources;
receiving link signal quality measurements that are based on the transmission of the channel and interference measurement signals over the plurality of resources;
exchanging link signal quality measurement information with at least one apparatus, wherein the exchange of the link signal quality measurement information comprises sending information based on the received link signal quality measurements; and
determining a data transmission schedule based on the exchange of the link signal quality measurement information.

2. The method of claim 1, further comprising coordinating with the at least one apparatus to identify the plurality of resources.

3. The method of claim 2, wherein coordinating with the at least one apparatus comprises exchanging messages via a wired or wireless interface or exchanging messages via an operations, administration, and management entity.

4. The method of claim 3, wherein exchanging messages via the wired or wireless interface comprises exchanging a measurement coordination message via the wired or wireless interface.

5. The method of claim 2, wherein coordinating with the at least one apparatus comprises:
sending an indication of resources being used by an access point; and
receiving at least one indication of resources being used by at least one other access point.

6. The method of claim 2, wherein coordinating with the at least one apparatus comprises exchanging messages that indicate at least one of: positions of the plurality of resources, periodicity associated with the plurality of resources, transmit power associated with the plurality of resources, or combinations thereof.

7. The method of claim 1, wherein the plurality of resources comprises at least one of: cell specific reference signal (CRS) resources, channel state information reference signal (CSI-RS) resources, interference management resources (IMR), or combinations thereof.

8. The method of claim 1, wherein the link signal quality measurement information comprises at least one of: a channel quality indicator (CQI), a precoding matrix indicator (PMI), a rank indicator (RI), a reference signal received power (RSRP) indicator, or combinations thereof.

9. The method of claim 8, wherein the CQI, PMI, or RI measurement information is obtained for one or more configurations of the plurality of resources for one or more cells.

10. The method of claim 8, wherein the RSRP indicator corresponds to one or more cells.

11. The method of claim 1, further comprising:
exchanging, in conjunction with the exchange of the link signal quality measurement information, configurations of channel and interference measurement signals determined through coordination with the at least one apparatus,
wherein the determination of the data transmission schedule is further based on the exchanged configurations.

12. The method of claim 1, wherein:
the link signal quality measurement information is derived from reference signal received power (RSRP) information;
the method further comprises exchanging, in conjunction with the exchange of the link signal quality measurement information, indications of access point conditions used to derive link signal quality; and
the determination of the data transmission schedule is further based on the exchanged indications.

13. The method of claim 1, further comprising:
exchanging, in conjunction with the exchange of the link signal quality measurement information, ancillary information comprising at least one of: access terminal rate information, access terminal throughput information, queue size information, backhaul bandwidth information, access terminal QoS requirements, or combinations thereof,
wherein the determination of the data transmission schedule is further based on the exchanged ancillary information.

14. The method of claim 1, wherein:
the received link signal quality measurements comprise measurements of reference signal power received at at least one access terminal for the at least one apparatus;
the method further comprises deriving channel quality information from the received link signal quality measurements; and
the information based on the received link signal quality measurements comprises the derived channel quality information.

15. The method of claim 1, further comprising processing the received link signal quality measurements, wherein the information based on the received link signal quality measurements comprises the processed received link signal quality measurements.

16. The method of claim 1, further comprising receiving at least one other data transmission schedule from the at least one apparatus, wherein the determination of the data transmission schedule is further based on the received at least one other data transmission schedule.

17. The method of claim 1, wherein exchanging the link signal quality measurement information comprises exchanging messages via a wired or wireless interface.

18. The method of claim 17, wherein exchanging messages via the wired or wireless interface comprises exchanging a link quality message via the wired or wireless interface.

19. The method of claim 1, wherein determining the data transmission schedule comprises defining the data transmission schedule.

20. The method of claim 19, further comprising sending the defined data transmission schedule to the at least one apparatus.

21. The method of claim 20, wherein sending the defined data transmission schedule comprises sending messages via a wired or wireless interface.

22. The method of claim 21, wherein sending messages via the wired or wireless interface comprises sending a scheduling coordination message via the wired or wireless interface.

23. The method of claim 1, wherein determining the data transmission schedule comprises receiving the data transmission schedule.

24. The method of claim 23, wherein receiving the data transmission schedule comprises receiving messages via a wired or wireless interface.

25. The method of claim 24, wherein receiving messages via the wired or wireless interface comprises receiving a scheduling coordination message via the wired or wireless interface.

26. The method of claim 1, wherein the determined data transmission schedule indicates at least one of: access point transmit timing, access point transmit power, transmit power for particular time and frequency resources, simultaneous use of resources, and combination thereof.

27. An apparatus for communication, comprising:
a transmitter configured to transmit channel and interference measurement signals over a plurality of resources;
a receiver configured to receive link signal quality measurements that are based on the transmission of the channel and interference measurement signals over the plurality of resources;
a wired or wireless transceiver configured to exchange link signal quality measurement information with at least one other apparatus, wherein the exchange of the link signal quality measurement information comprises sending information based on the received link signal quality measurements; and
a processor configured to determine a data transmission schedule based on the exchange of the link signal quality measurement information.

28. The apparatus of claim 27, wherein:
the processor is further configured to coordinate with the at least one apparatus to identify the plurality of resources; and
the wired or wireless transceiver is further configured to support the coordination with the at least one apparatus by exchanging messages via a wired or wireless interface or exchanging messages via an operations, administration, and management entity.

29. The apparatus of claim 27, wherein the wired or wireless transceiver is further configured to:
exchange, in conjunction with the exchange of the link signal quality measurement information, configurations of channel and interference measurement signals determined through coordination with the at least one apparatus,
wherein the determination of the data transmission schedule is further based on the exchanged configurations.

30. An apparatus for communication, comprising:
means for transmitting channel and interference measurement signals over a plurality of resources;
means for receiving link signal quality measurements that are based on the transmission of the channel and interference measurement signals over the plurality of resources;
means for exchanging link signal quality measurement information with at least one apparatus, wherein the exchange of the link signal quality measurement information comprises sending information based on the received link signal quality measurements; and
means for determining a data transmission schedule based on the exchange of the link signal quality measurement information.
